(19) United States
(12) Patent Application Publication
(10) Pub. No.: US 2010/0083251 A1
(43) Pub. Date: Apr. 1, 2010

(54) Techniques For Identifying And Comparing Virtual Machines In A Virtual Machine System

(75) Inventors: DAVE DENNIS MCCRORY, Pflugerville, TX (US); JAMES DANIEL SNYDER, II, CEDAR PARK, TX (US); WADE ALLEN REYNOLDS, CEDAR PARK, TX (US); BRIAN HAY MORTIMORE, LEANDER, TX (US); JONATHAN MARK REEVE, AUSTIN, TX (US)

Correspondence Address: DILLON & YUDELL LLP, 8911 NORTH CAPITAL OF TEXAS HWY, SUITE 2110, AUSTIN, TX, 78759, US

(73) Assignee: HYPER9, INC., Austin, TX (US)

(21) Appl. No.: 12/557,734

(22) Filed: Sep. 11, 2009

Related U.S. Application Data
(60) Provisional application No. 61/096,547, filed on Sep. 12, 2008.

(51) Int. Cl. G06F 9/455

(52) U.S. Cl. 718/1

(57) ABSTRACT

A technique for identifying virtual machines (VMs) in a VM system includes determining a configuration file location on a data store for the VM. A VM manager (for the VM) and an associated VM identification assigned to the VM (by the VM manager) are determined. A unique VM identification is then created based on the configuration file location on the data store, the VM manager, and the associated VM identification.

This application claims the benefit of the filing date of U.S. Provisional Patent Application Ser. No. 61/096,547, entitled “TECHNIQUES FOR IDENTIFYING VIRTUAL MACHINES IN A VIRTUAL MACHINE SYSTEM,” filed Sep. 12, 2008, the entire disclosure of which is hereby incorporated herein by reference in its entirety for all purposes.

### BACKGROUND

1. Field

This disclosure relates generally to virtual machines and, more specifically to techniques for identifying and comparing virtual machines in a virtual machine system.

2. Related Art

In computer science, a virtual machine (VM) is a software implementation of a real machine (computer system) that executes programs like the real machine. VMs are usually separated into two major categories (i.e., system VMs and process VMs), based on their use and degree of correspondence to a real machine. A system VM provides a complete system platform which supports the execution of a complete operating system (OS). In contrast, a process VM is designed to run a single program and support a single process. Software running inside a VM is limited to the resources and abstractions provided by the VM. System VMs (hardware VMs) allow the sharing of the underlying physical machine resources between different VMs, each running its own OS. The software layer providing the virtualization is called a VM monitor (hypervisor).

A VM monitor can run on bare hardware (type 1 or native VM) or on top of an OS (type 2 or hosted VM). The main advantages of system VMs are that multiple isolated OSs can co-exist on a same host computer system (host) and a VM can provide an instruction set architecture (ISA) that is different from that of the host. Multiple VMs each running their own OS (called guest OSs) are frequently used in server consolidation, where different services that formerly ran on individual machines (in order to avoid interference) are instead ran in separate VMs on the same physical machine. The desire to run multiple OSs on a single computer system provided the original motivation for VMs, as it allowed time-sharing of the single computer system between several single-tasking OSs. The guest OSs may correspond to different OSs (e.g., Microsoft™ Windows, Solaris™, Linux™, or older versions of an OS in order to support software that has not yet been ported to the latest version of the OS). Another use of VMs is to isolate an OS that is not trusted, for example, because the OS is under development. In general, VMs facilitate better debugging access and faster reboot during OS development.

Information technology (IT) administrators have typically manage virtualized systems in the same way that IT administrators have managed non-virtualized systems. A typical conventional virtual machine (VM) manager has provided a windows-based view that has allowed an IT administrator to view configuration and operational characteristics of multiple VMs, typically in a serial manner. From a management perspective, the conventional VM manager is sufficient when a relatively small number of VMs (e.g., less than about 100 VMs) are being managed. Unfortunately, conventional windows-based VM management becomes unwieldy as the number of managed VMs becomes relatively large (e.g., greater than about 100 VMs). Moreover, VMs are difficult to track using conventional approaches, especially when VMs are moved from one host to another host. In addition, if a VM is not readily locatable, then it is difficult to mange the VM. Traditionally, VM applications, such as VMware™, have provided management software (e.g., VirtualCenter™) to provide a view into a host, which corresponds to a physical machine with an installed VM monitor. In general, VirtualCenter™ facilitates provisioning VMs and monitoring performance of hosts and VMs. At least one VM manager has been configured to track and record changes in a VM as the changes occur. Unfortunately, if a change is not recorded, from the perspective of the VM manager, the change never occurred.

### SUMMARY

According to one aspect of the present disclosure, a technique for identifying virtual machines (VMs) in a VM system includes determining a configuration file location on a data store for the VM. A VM manager (for the VM) and an associated VM identification assigned to the VM (by the VM manager) are determined. A unique VM identification is then created based on the configuration file location on the data store, the VM manager, and the associated VM identification. In general, the technique does not require injection of data into a VM configuration file or into contents of a VM virtual hard disk.

According to another aspect of the present disclosure, a technique for managing virtual machines in a virtual machine system includes creating unique virtual machine identifications for the virtual machines of the virtual machine system based at least on respective configuration file locations for the virtual machines, a virtual machine manager for each of the virtual machines, and associated virtual machine identifications assigned to the virtual machines by the virtual machine manager for each of the virtual machines. Respective configuration data on the virtual machines is collected. One or more respective virtual machine signatures for each of the virtual machines are then created, from at least some of the respective configuration data. The respective virtual machine signatures are associated with appropriate ones of the unique virtual machine identifications. Finally, a first signature is compared with a second signature to determine a configuration difference between a first virtual machine and a second virtual machine (both of which are included within the virtual machines). In this case, the first and second signatures are included within the respective virtual machine signatures.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a diagram of an example virtual machine (VM) system that is configured to identify and compare VMs according to various aspects of the present disclosure.

FIG. 2 is a table of an example process for identifying VMs according to one embodiment of the present disclosure.

FIG. 3 is a flowchart of an example process for identifying VMs according to one embodiment of the present disclosure.

FIG. 4 is a flowchart of an example process for managing VMs according to one embodiment of the present disclosure.

### DETAILED DESCRIPTION

As will be appreciated by one of ordinary skill in the art, the present invention may be embodied as a method, system, device, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a circuit, module, or system. The present invention may, for example, take the form of a computer program product on a computer-usable storage medium having computer-usable program code embodied in the medium. The present invention may also take the form of software that executes inside of a virtual machine (VM).

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium include: a portable computer diskette, a hard disk, a random access memory (RAM), a read-only memory (ROM), an erasable programmable read-only memory (EPROM) or flash memory, a portable compact disc read-only memory (CD-ROM), an optical storage device, or a magnetic storage device. As may be used herein, the term “coupled” includes a direct electrical connection between elements or blocks and an indirect electrical connection between elements or blocks achieved using one or more intervening elements or blocks.

According to various aspects of the present disclosure, data is periodically collected about a virtual machine (VM) and the collected data is then analyzed to determine whether changes have occurred in the VM. The collected data may then be indexed and stored for later comparison with other indexed data (e.g., data associated with the same VM or a different VM). Typically, it is not practical to do a line-by-line item comparison of indexed data. For example, data of a configuration file of an application may be written to the configuration file in a number of different ways. As such, if a line-by-line comparison is performed on configuration files, the comparison may indicate that one of the configuration files is entirely different when in reality the data in the configuration file may be ordered differently but is otherwise exactly the same. According to one aspect of the present disclosure, one or more unique VM signatures are created for each managed VM. In general, the techniques disclosed herein are passive and do not inject or place any data, markers, keys, signatures, etc. into a VM.

In at least one embodiment, lossey compression is employed to create VM signatures. In this manner, data that is considered less important may be omitted when a VM signature is created. It should be appreciated that reducing the amount of data facilitates more rapid comparison between VM signatures. When two VM signatures are exactly the same, then it is not generally necessary to further examine the VM signatures. However, if two VM signatures vary in particular areas, then those areas may warrant further investigation.

In general, the disclosed techniques facilitate storing obfuscated data, as contrasted with actual data. The obfuscated data may, for example, correspond to a subset of a large volume of data. For example, the subset of data may correspond to different attributes that are known to primarily effect operation of a VM. According to another aspect of the present disclosure, different VM signatures may be compared to determine a difference between associated VMs. The VM signatures may correspond to hashed strings that can be compared to each other to determine how similar (or how different) the hashed strings are with respect to each other. The hashes employed may be designed to be fuzzy hashes such that minor differences in compared strings are not flagged as completely different strings. For example, if the only difference between two VMs was that a gateway service was started on one VM and stopped on the other VM, associated VM signatures would not be flagged as completely different (as contrasted with comparison of a traditional hash which would cause the VM signatures (strings) to be flagged as completely different).

One rationale for comparing two different VMs at any given point in time is to determine why the VMs are not operating in the same manner. For example, when the VMs are clones in a web farm, the VMs should operate in the same manner. As another example, VMs may also be compared to each other for compliance purposes. For example, a fully compliant secured VM may be compared to other VMs in a network with the VMs that are different by more than a predetermined percentage, e.g., fifteen percent, being flagged for further review. A non-compliant VM may, for example, indicate there is a malicious application running on the non-compliant VM, the non-compliant VM is misconfigured, or the non-compliant VM is not properly secured (including old, expired, or deleted user accounts and drives that are mounted and shared but should not be mounted and/or shared). Due to the lossey nature of the fuzzy hash function, data associated with a VM signature is difficult to reverse engineer. For example, data such as passwords may be intentionally discarded prior to hashing. As another example, VM signatures for two different systems that implement an SAP™ configuration (which refers to a well-known enterprise resource planning (ERP) based suite of software) of four VMs may be compared to determine why one of the SAP™ configurations only supports one-thousand users while the other SAP™ configuration supports five-thousand users.

Comparing VM signatures provides indicators of the differences between the VM systems. For example, the difference may lie in the virtual hardware, the operating systems (OSs), the configuration files, or elsewhere. In general, being able to determine an optimal or reference architecture configuration is highly valuable. In this manner, knowledge can be shared to efficiently model VMs. Moreover, saving VM signatures at different points in time facilitates troubleshooting a VM when a problem occurs. Effectively, a VM manager can predict (with some history and/or outside knowledge) optimal configurations for a VM. For example, the VM manager may utilize a VM signature to determine whether there are settings in an application (e.g., Apache™) that make the application run poorly on a VM. Moreover, VM signatures may be compared to known good and bad VM signatures to determine if a configuration of an associated VM may be improved. Following this approach, VM signatures may be created for each layer of a system.

A difference between VM signatures may correspond to a graph edit distance, which provides an indication of how many changes are required for one VM signature to equal another VM signature. In general, data values and one or more levels of processed data values may be stored to provide an efficient manner of doing comparisons. For example, if a higher level of processed data values is virtually unchanged between compared VM signatures, further comparison of the VM signatures at a lower level would generally not be warranted. According to this aspect of the present disclosure, a multiple level process of indexing data values may be employed that provides a different granularity at each of the multiple levels. Employing VM signatures also provides a way for individuals to share relevant information in an obfuscated manner to facilitate troubleshooting for non-related entities.

Depending on a granularity of a VM signature provided, a problem may be identified in a VM configuration, a guest OS configuration, a registry, etc. As another example, comparing VM signatures for a VM may indicate that on installation the VM was roughly configured in a first configuration and at a later date five files associated with the VM have changed. The VM signatures may also indicate that only one of the five files included significant changes. In this manner, troubleshooting may be focused on the file with significant changes. The same capability may be applied to compare hosts (e.g., one host may be compared to another host or a host may be compared to itself at different points in time), as well as data centers (e.g., one data center may be compared to another data center or a data center may be compared to itself at different points in time).

Today, an individual VM system may implement multiple thousands (e.g., tens or hundreds of thousands) of individual VMs on a network of hosts. In order to successfully manage VMs of such VM systems, management software must usually be capable of uniquely distinguishing between the VMs. Conventional approaches to identifying VMs has required internal review of associated VM configuration files (e.g., VMware™.vmx files). According to one or more aspects of the present disclosure, techniques are implemented to discover and identify virtual machines (VMs) without requiring internal review of associated VM configuration files. In this manner, VM identity resolution may be performed in a timely fashion without actually looking at internal contents of a VM configuration file. For example, according to various aspects of the present disclosure, each VM can be thought of as having a shipping container that uniquely identifies the VM. As such, examining the shipping container of a VM facilitates determining, with a relatively high level of probability, whether the VM corresponds to a known VM (e.g., a known VM that has been moved to a new host, or a known VM whose VM configuration file has been moved to a different storage location) or corresponds to a new VM (e.g., a VM that is a clone of a known VM). In the event that a VM cannot be identified at a desired level, input may be sought from an appropriate individual (via a host associated with the individual).

According to at least one embodiment of the present disclosure, a VM system is configured to collect information for each VM, without first identifying the VM. The VM system later processes (e.g., at a remote management (search center) server) the collected information to determine whether information had been previously collected for the VM or if the information is for a new VM. When information is collected for a previously known VM, the information may be attached to (e.g., concatenated with) previously collected information for the VM.

In a typical application, there is a number of criteria that may be collected to provide a unique VM identification (ID). The unique VM ID may then be compared with known VM IDs to determine whether information has been previously collected for the VM. As one example, five pieces of data may be collected to provide a unique VM ID for each VM. In any event, it is desirable that the collected data facilitate unique identification of a VM, even when the VM has been moved, renamed, or cloned or a configuration file associated with the VM has been moved on a data store or to a new data store. According to one aspect of the present disclosure, the five pieces of data include: first data that corresponds to a data store universal unique identifier (DS.UUID); second data that corresponds to a relative path that is traversed to a configuration file (e.g., a .vmx file); third data that corresponds to a name of the configuration file; fourth data that corresponds to a VM universal unique identifier (VM.UUID) that a VM manager (e.g., VirtualCenter™) utilizes to identify the VM; and fifth data that identifies the VM manager. It should be appreciated that more or less than five pieces of data may be utilized to uniquely identify a VM according to the present disclosure.

The DS.UUID uniquely identifies a file system (e.g., a virtual machine file system (VMFS)) volume. In the event that a VM is moved from one host to another host (e.g., using a VMware™ Vmotion), the DS.UUID does not usually change as the file system volume (e.g., included in a storage area network (SAN) or direct attached storage) is typically accessible to the different hosts. The relative path provides information if a VM configuration file is moved or copied to another directory. The VM configuration file defines a VM and includes the VM.UUID and a number of parameters that define an associated VM. For example, the parameters may include a medium access control (MAC) address, assigned memory, assigned CPU(s), reserved resources, assigned virtual network interface cards (NICs), etc.

Typically, each of the VM configuration files includes a basic input/output system (BIOS) UUID (that corresponds to a VM.UUID) that is used by a VM manager to identify a VM. However, VM configuration files may be manually copied and, as such, it is possible that more than one VM may have the same VM.UUID. Moreover, many larger VM systems employ multiple VM managers that may each assign a same VM.UUID to associated ones of the VMs. In either case, a VM.UUID may not function to uniquely identify a VM. Various VM tools (e.g., VMware™) implement management products (e.g., VirtualCenter™) to manage hosts and associated VMs. As one example, VirtualCenter™ employs an agent (that is included in a VM monitor on each host) to communicate with a host.

In general, VirtualCenter™ examines a VM.UUID when an agent attempts to register a .vmx file. If the VM.UUID is not a duplicate VM.UUID, VirtualCenter™ registers the .vmx file. In this manner, a VM manager prevents duplicate VM.UUIDs on hosts managed by the VM manager. However, as noted above, when hosts are not being managed by a same VM manager, duplicate VM.UUIDs may occur. Moreover, when a VM is copied to another platform (e.g., from a VMware™ platform to a HyperV™ platform) duplicate VM.UUIDs may occur. For example, when a VM is manually cloned, unlike when a VM is cloned using VMware™ tools, a VM.UUID is not automatically changed. As another example, when a VM is moved from an old host to a new host, even though the host has changed, the VM is the same and data previously collected on the VM (prior to the host change) should be associated with data collected for the VM on the new host.

In various embodiments, each of the five pieces of data correspond to a string (e.g., a character string, a numeric string, or a string that includes characters and numbers) of a known length. For example, each of the five pieces of data may be hashed, truncated, or padded to correspond to thirty-two bits. In a typical implementation, each of the five pieces of data are hashed (e.g., using a cyclic redundancy check (CRC) or other hashing function) to provide a string having a known length (e.g., thirty-two bits, sixty-four bits, etc.). In this manner, each of the five pieces of data may be combined (e.g., concatenated) to provide a unique VM ID.

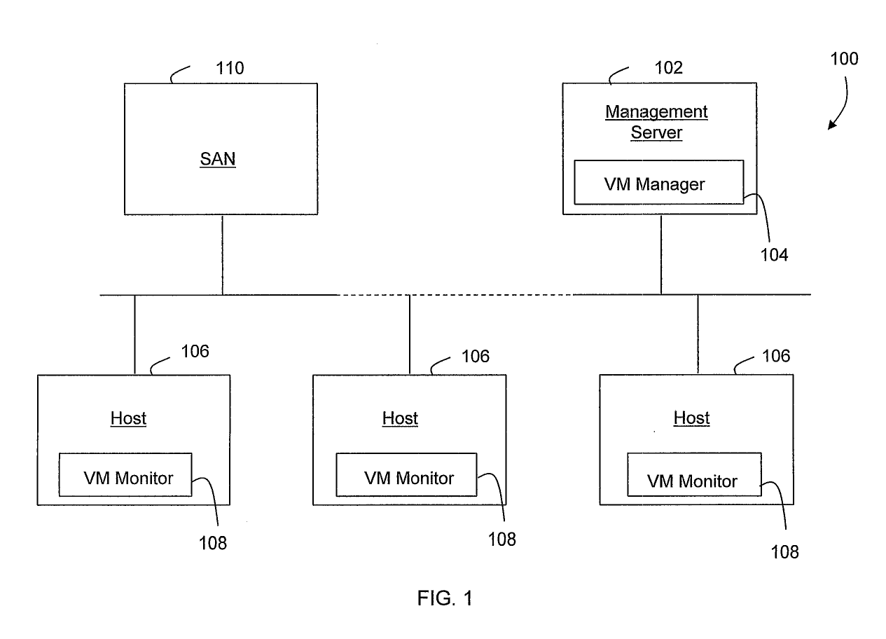

With reference to FIG. 1, an example VM system 100 is illustrated. The system 100 includes multiple hosts 106 that each include a VM monitor 108. The hosts 106 communicate with one or more SANs 110 (only one of which is shown) and one or more management servers 102 (only one of which is shown) each of which include a VM manager 104 (e.g., a VMware VirtualCenter™). In a typical implementation, the management server 102 is configured to facilitate search (as well as storage) functions that allow one VM to be compared to another VM (or more accurately one VM signature to be compared with another VM signature). It should be appreciated that a VM system configured according to the present disclosure may include one or more SANs, more or less than three hosts, and one or more VM managers. The VM system 100 may be, for example, an Internet protocol (IP) based system, or other type of system.

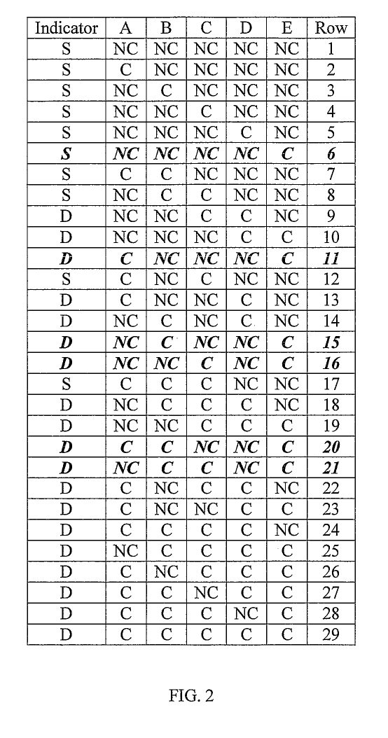

With reference to FIG. 2, a table 200 illustrates the implementation of an example process for comparing VM IDs and determining (or providing an indication of) whether a VM ID corresponds to a known VM ID. In the table 200, a ‘C’ indicates that an associated data piece has changed (as compared with a data piece of a known VM) and a ‘NC’ indicates that the associated data piece has not changed (as compared with a data piece of a known VM). In rows 2-6 of the table 200, one piece of data has changed in each of the rows. In rows 7-16 of the table 200, two pieces of data have changed in each of the rows. In rows 17 -3 of the table 200, three pieces of data have changed in each of the rows. In rows 24-28 of the table 200, four pieces of data have changed in each of the rows. In row 29 of the table 200, all five pieces of data have changed. With reference to column 1 (labeled ‘Indicator’) of the table 200, according to the implemented process, a same VM is indicated by the designator ‘S’ and a different VM is indicated by the designator ‘D’. In rows 6, 11, 15, 16, 20, and 21, (emphasized with italicized and bolded text) further input may be needed to actually determine whether the VM is the same or different than a known VM. It should be appreciated that processes, other than the process illustrated in the table 200, may be utilized to indicate whether a VM is the same or different than a known VM.

With reference to row 17, if A (which corresponds to the DS.UUID), B (which corresponds to the relative path), and C (which corresponds to the configuration file name) have all changed but D (which corresponds to the VM.UUID) and E (which corresponds to the VM manager) are the same, then it can be assumed that the VMs are the same. In this case, the assumption is considered valid because the VM.UUID is the same and the VM manager is the same (as the VM manager should have assigned a new VM.UUID to the VM if the VM was a new VM). There are, however, circumstances where a VM manager (managing entity) changes and there is not enough information to determine (to a desired certainty) whether a VM corresponds to a known VM. That is, if management of a VM is changed from one VM manager to another VM manager, it can be difficult (based on available information) to determine if the VM corresponds to a known VM.

With reference to row 1 of FIG. 2, if none of the data pieces have changed (as compared to a known VM ID), then an assumption is made that the VM corresponds to a known VM. When either one, two or three of A, B, or C have changed, as long as the VM manager has not changed an assumption is made that the VM is the same as a known VM (see rows 2-5, 7, 8, 12, and 17). With reference to row 6, even when the VM.UUID is changed, an assumption is made that the VM corresponds to a known VM as the storage volume, relative path, and configuration file name are the same and the configuration file is still managed by the same VM manager. In this case, an assumption is made that the VM manager must have changed the VM.UUID for some valid reason.

According to another aspect of the present disclosure, a combination of three identity parameters may be combined to uniquely identify a VM (i.e., provide an identity function for the VM) as follows:

[Data_store URL/VM Config File Dir]+[VM Config File Name]+[VM UUID] where a=[Data_store URL/VM Config File Dir]; b=[VM Config File Name]; and c=[VM UUID]. According to this aspect of the present disclosure, if two of the three parameters (‘a’, ‘b’, and ‘c’) match then the VM is assumed to correspond to a known VM. The parameter ‘a’includes two parts: the data store uniform resource locator (URL) and the full directory path in which the configuration file for the VM resides. In this example, the two parts are separated by a literal ‘/’ character. For example, the data store URL may be /vmfs/volumes/486a44f9-da260d58-d3c3-00e081494606 and the configuration file directory may be cto-w2k3-vm3/. In this case, the value of ‘a’ is /vmfs/volumes/486a44f9-da260d58-d3c3-00e081494606/cto-w2k3-vm3/. The parameter ‘b’ includes the configuration file name of the VM. For example, the configuration file name may be cto-w2k3-vm3.vmx. In this case, the value of ‘b’ is cto-w2k3-vm3.vmx. The parameter ‘c’ includes the UUID of the VM (i.e., the VM.UUID). For example, the VM.UUID may be 564d466d-24fe-0dc6-800b-e63a9e6b60f3. In this case, the value of ‘c’ is 564d466d-24fe-0dc6-800b-e63a9e6b60f3. A consolidated view of the examples above is as follows:

a=/vmfs/volumes/486a44f9-da260d58-d3c3-00e081494606/cto-w2k3-vm3

b=cto-w2k3-vm3.vmx/c

c=564d466d-24fe-0dc6-800b-e63a9e6b60f3

The first two parameters essentially define a unique location of a VM configuration file. The VM.UUID is essentially a cloning guard for VMware™, since a VM is (typically) assigned a unique VM.UUID the first time a VM is powered on (or when the VM is registered for VMware™ ESX>=3.5) Together, the three parameters define file location uniqueness and execution uniqueness.

A purpose of an identity function is to uniquely identify a VM in a managed environment, where a VM is defined as a logical container (in general, identity functions should not make assumptions about the guest OS above or the physical hardware below). That is, the more assumptions that are made about a guest OS or physical hardware, the greater the possibility of inaccuracies. Another purpose of an identity function is to preserve the identity of a VM when a regular and/or a storage Vmotion (i.e., movement of execution to a different host and/or movement of a configuration file to a different data store) is implemented. Conceptually, the combined identity parameters provide a VM display name that is independent of an actual VM identity (i.e., the VM display name can change, but it is still the same VM). For example, a VM display name may be initially set to a display name given by the VM configuration file (e.g., the .vmx file for VMware™).

A regular Vmotion from a first host to a second host requires that both hosts are using the same shared storage. When a VM is dynamically moved from the first host to the second host, the file location ‘a.b’ does not change. When a VM that has never been powered on is dynamically moved from one host to another host, ‘c’ is usually equal to NULL. As such, ‘a.b.c’ will usually be the same before and after the dynamic move. In VMware™ ESX 3.0, a VM.UUID may be NULL if a VM has never been powered on. However, in VMware™ ESX 3.5 a VM will typically have an assigned VM.UUID as long as the VM is registered. When a VM is dynamically moved from one host to another host that has been powered on before (and has a VM.UUID assigned), the VM may be in an ‘on’, ‘off’, or ‘suspended’ state. In this case, the file location is not moved (a.b) and the VM.UUID remains the same after the dynamic move.

For storage Vmotion, VMware™ actually moves the VM configuration file (i.e., between data stores). In this case, since the data store has changed, ‘a’ (the DS.UUID) changes. However, ‘b.c’ does not change. In this case, an assumption may be made that the VM is the same VM, as two out of the three identity parameters are the same. In a combined regular and storage Vmotion, both the execution of the VM, and the VM configuration file itself are moved. This case is similar to the previous case in that ‘a’ (the DS.UUID) is expected to change, but ‘b.c’ is expected to remain the same. In certain types of third party products (e.g., Veritas™ back-up software), vendors recommend changing the VM.UUID manually to attempt to make it unique. In this case, configuration errors may occur when a user explicitly configures non-unique VM.UUIDs. As ‘c’ changes but ‘a.b’ remain the same, an assumption may be made that the VM is the same VM.

According to, above described aspect of the present disclosure, three values ('a', ‘b’, and ‘c’) may be obtained using a virtual infrastructure (VI) application programmer interface (API). For example, {DATASTORE_URLNM_CONFIG_FILE_DIR] may be obtained from an object graph vm.config.data_storeUrl.url (where vm is a ManagedObjectReference to a VM instance). In this case, the directory part is parsed from the absolute data store/path/filename value. [VM_CONFIG_FILE_NAME] may be obtained from an object graph vm.summary.config.vmPathName (where vm is a ManagedObjectReference to a VM instance). In this case, the filename part may be parsed from the absolute data store/path/filename value. [VM_UUID] may be obtained from an object graph vm.config.uuid (where vm is a ManagedObjectReference to a VM instance). As one example, a VI API may be utilized to obtain a ManagedObjectReference to a VM instance stored in a variable named vm according to the pseudo code set forth below:
ManagedObjectReference vm={Code to get VM}

A new string variable named vmUuid may be created and assigned the value from the property call string vmUuid=vm.config.uuid. A new string variable named vmPath may be created and assigned the value from the property call string vmPath=vm.summary.config.vmPathName. A new string variable named dsAlias may be created and the data store alias part of the value may be parsed and assigned to vmPath while assigning the remaining trimmed value to vmPath as follows:

string dsAlias = {Code to parse data store alias from vmPath}
vmPath = vmPath.Replace(dsAlias, “”).Trim( );

The data store URL may then be looked-up in the vm.config.data_storeUrl (which returns an array) to find a data store that matches the value of dsAlias. A new string variable named dsUrl may be created and assigned the value from the URL property of the matching data store (such as vm.config.data_storeUrl[0].url, where 0 is the index of the matching data store alias) as follows:

```
string dsUrl = null;
VirtualMachineConfigInfoData_storeUrlPair[ ] pairs =
vm.config.data_storeUrl;
for each (VirtualMachineConfigInfoData_storeUrlPair pair in pairs)
{
  if (pair.name == dsAlias)
  {
    dsUrl = pair.url;
    break;
  }
}
```

A new string variable named vmIdentity may then be created and assigned the concatenated values of dsUrl, vmPath, and vmUuid as follows:
string vmIdentity=dsUrl+vmPath+“?”+vmUuid;

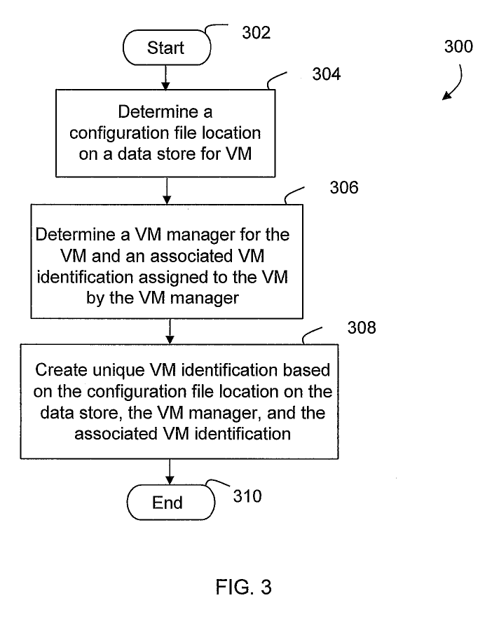

With reference to FIG. 3, an example process 300 for identifying a VM (in a VM system) is illustrated. In block 302, the process 300 is initiated. Next, in block 304, a configuration file location on a data store is determined for the VM. Then, in block 306, a VM manager for the VM and an associated VM identification assigned to the VM by the VM manager are determined. Next, in block 308, a unique VM identification is created based on the configuration file location on the data store, the VM manager, and the associated VM identification. Following block 308 control transfers to block 310 where the process 300 terminates and control returns to a calling routine. As noted above, the techniques disclosed herein are passive and do not inject or place any data, markers, keys, signatures, etc. into a VM.

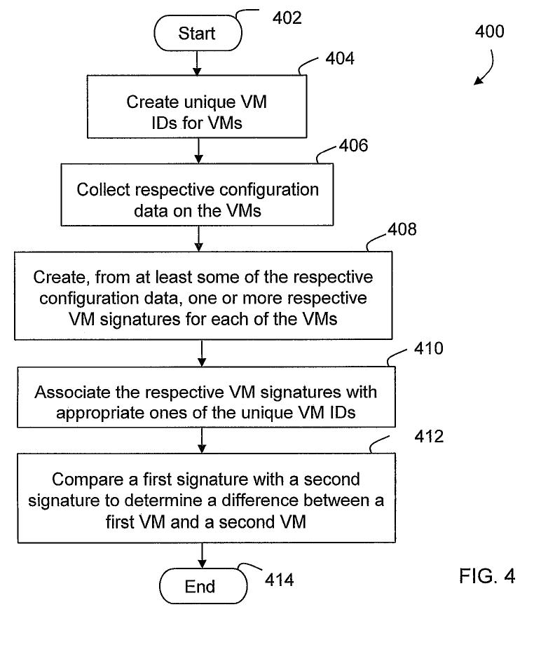

With reference to FIG. 4, an example process 400 for managing VMs in a VM system is illustrated. The process 400 (which may, for example, be implemented in the management server 102) is initiated in block 402, at which point control transfers to block 404. In block 404, unique VM identifications are created for the VMs of the VM system based at least on respective configuration file locations for the VMs, a VM manager for each of the VMs, and associated VM identifications assigned to the VMs by the VM manager for each of the VMs.

Next, in block 406, respective configuration data on the VMs is collected. Then, in block 408, one or more respective VM signatures for each of the VMs are created, from at least some of the respective configuration data. Next, in block 410, the respective VM signatures are associated with appropriate ones of the unique VM identifications. Then, in block 412, a first signature is compared with a second signature to determine a configuration difference between a first VM and a second VM (both of which are included within the VMs). In this case, the first and second signatures are included within the respective VM signatures. Next, control transfers from block 412 to block 414 where the process 400 terminates and control returns to a calling routine.

Accordingly various techniques have been disclosed herein that uniquely identify a VM using a VM configuration file location on a data store, a VM identification assigned to the VM by a VM manager, and the VM manager. The VM configuration file location may be given by a path to the VM configuration file on a data store device. The VM may be identified by a VM.UUID that is assigned to the VM by a VM manager. The VM manager may be a host of the VM or the VM manager may be a higher level application (e.g., VirtualCenter™) that actually manages the host and VM. The disclosed techniques are particularly advantageous when implemented in VM systems that allow VMs and associated configuration files to be moved to address utilization (i.e., under-utilization and over-utilization of a host and/or data store), failure (i.e., of a host and/or data store), maintenance (i.e., of a host and/or data store), and/or power usage (i.e., of a host and/or data store). Moreover, techniques disclosed herein facilitate comparison of VM configuration data to aid in troubleshooting and optimization of VMs of a VM system.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” (and similar terms, such as includes, including, has, having, etc.) are open-ended when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of identifying a virtual machine in a virtual machine system, comprising:
determining a configuration file location on a data store for the virtual machine;
determining a virtual machine manager for the virtual machine and an associated virtual machine identification assigned to the virtual machine by the virtual machine manager; and
creating a unique virtual machine identification for the virtual machine based on the configuration file location on the data store, the virtual machine manager, and the associated virtual machine identification.

2. The method of claim 1, wherein the configuration file location on the data store includes a first string that identifies a data store volume identification, a second string that identifies a name for the configuration file, and a third string that identifies a relative path for the configuration file, and wherein no data, markers, keys, or signatures, are injected into the virtual machine.

3. The method of claim 2, wherein the first, second, and third strings are individual hashed strings.

4. The method of claim 2, wherein one or more of the first, second, and third strings are fuzzy hashed strings.

5. A virtual machine system, comprising:
a storage area network including data stores;
host computer systems each including one or more virtual machine monitors for monitoring one or more virtual machines; and
a management server including a virtual machine manager, wherein the virtual machine manager is in communication with the storage area network and the virtual machine monitors, and wherein the management server is configured to:
create unique virtual machine identifications for virtual machines of a virtual machine system based at least on respective configuration file locations for the virtual machines, a virtual machine manager for each of the virtual machines, and associated virtual machine identifications assigned to the virtual machines by the virtual machine manager for each of the virtual machines;
collect respective configuration data on the virtual machines;
create, from at least some of the respective configuration data, one or more respective virtual machine signatures for each of the virtual machines;
associate the respective virtual machine signatures with appropriate ones of the unique virtual machine identifications; and
compare a first signature with a second signature to determine a configuration difference between a first virtual machine and a second virtual machine both of which are included within the virtual machines, wherein the first and second signatures are included within the respective virtual machine signatures.

6. The virtual machine system of claim 5, wherein the first virtual machine and the second virtual machines correspond to a same one of the virtual machines at different times.

7. The virtual machine system of claim 5, wherein the first virtual machine and the second virtual machine correspond to different ones of the virtual machines.

8. The virtual machine system of claim 5, wherein at least some of the respective configuration data that is collected is not used to create the respective virtual machine signatures.

9. The virtual machine system of claim 5, wherein the respective virtual machine signatures correspond to respective hashed strings.

10. A method for managing virtual machines in a virtual machine system, comprising:
creating unique virtual machine identifications for virtual machines of a virtual machine system based at least on respective configuration file locations for the virtual machines, a virtual machine manager for each of the virtual machines, and associated virtual machine identifications assigned to the virtual machines by the virtual machine manager for each of the virtual machines;
collecting respective configuration data on the virtual machines;
creating, from at least some of the respective configuration data, one or more respective virtual machine signatures for each of the virtual machines;
associating the respective virtual machine signatures with appropriate ones of the unique virtual machine identifications; and
comparing a first signature with a second signature to determine a difference between a first virtual machine and a second virtual machine both of which are included within the virtual machines, wherein the first and second signatures are included within the respective virtual machine signatures.

11. The method of claim 10, wherein the first virtual machine and the second virtual machine correspond to a same one of the virtual machines at different times.

12. The method of claim 10, wherein the first virtual machine and the second virtual machine correspond to different ones of the virtual machines.

13. The method of claim 10, wherein at least some of the respective configuration data that is collected is not used to create the respective virtual machine signatures.

14. The method of claim 10, wherein the respective virtual machine signatures correspond to respective hashed strings.

15. The method of claim 10, wherein the respective virtual machine signatures correspond to respective fuzzy hashed strings.

16. The method of claim 10, wherein the virtual machines correspond to clones in a web farm.

17. The method of claim 10, wherein the first virtual machine is a compliant virtual machine and the second virtual machine is a non-compliant virtual machine that is misconfigured or not properly secured.

18. The method of claim 10, wherein the difference between the first virtual machine and the second virtual machine is associated with one or more of differences in virtual hardware, operating systems, and configuration files.

19. The method of claim 10, wherein the difference between the first and second signatures corresponds to a graph edit distance which provides an indication of how many changes are required for the first and second signatures to be equal.

20. The method of claim 10, wherein the virtual machine signatures are created for each layer of the virtual machine system.
